(19) United States
(12) Patent Application Publication
(10) Pub. No.: US 2016/0221028 A1
(43) Pub. Date: Aug. 4, 2016

(54) Method of Coating a Substrate

(71) Applicant: BENEQ OY, Espoo (FI)

(72) Inventors: Ville Alitalo, Espoo (FI); Kai Asikkala, Espoo (FI); Simo Tammela, Espoo (FI); Sauli Virtanen, Espoo (FI)

(21) Appl. No.: 14/915,676

(22) PCT Filed: Sep. 2, 2014
(86) PCT No.: PCT/FI2014/050668

§ 371 Date: Mar. 1, 2016

(30) Foreign Application Priority Data
Sep. 9, 2013 (FI) 20135904

(51) Int. Cl. B05D 1/02; B05D 1/30; B05B 1/26

(52) U.S. Cl. CPC B05D 1/02; B05B 1/26; B05D 1/30

(57) ABSTRACT

The invention relates to a method of coating a substrate in a deposition chamber. The method comprising the steps of providing a source of at least one liquid precursor; atomizing the at least one liquid precursor into liquid droplets in the deposition chamber for producing aerosol; filling the deposition chamber with aerosol for forming saturated aerosol in the deposition chamber; and settling saturated aerosol by gravitation towards a surface of the substrate for coating the substrate in the deposition chamber.

### FIELD OF THE INVENTION

The present invention relates to a method of coating a substrate, and more particularly to what is stated in the preamble of independent claim 1.

The present invention relates especially to coating substrates with aerosol produced in a deposition chamber.

### BACKGROUND OF THE INVENTION

The invention relates to generating aerosol in which the term aerosol means a fine fog of liquid droplets.

In the prior art a typical coating of a substrate happens in a deposition chamber by directing an aerosol jet toward the substrate such that the droplets of the aerosol jet are directed to the surface of the substrate to be coated. This type of coating is achieved by arranging the atomizing head facing to the surface of the substrate to be coated so that the aerosol jet is directed to a first impingement point on a surface of the substrate and then the aerosol travels on the surface of the substrate to a second point where the aerosol which has not participated in the coating process is removed.

A disadvantage associated with the above mentioned arrangement is that the coating is not uniform and may comprise a striped effect on the surface of the substrate due to uneven distribution of the aerosol from the atomizer.

Another prior art solution is that two atomized aerosol jets are oriented in a manner making them collide into one another so that aerosol is produced and then the produced aerosol is moved toward the substrate to be coated preferably by blowing to it. By orienting the aerosol jets substantially directly against each other, aerosol is produced, the mobility thereof being momentarily approximately non-existent, whereby said aerosol may be moved in the desired direction with a separate gas flow oriented substantially to the collision point of the aerosol jets.

One of the disadvantages associated with the above arrangement is that the coating may not be even everywhere on the surface of the substrate. In practice, it has unfortunately proven difficult to provide sufficiently uniform coatings and the coating thickness variation over the substrate is too high.

### BRIEF DESCRIPTION OF THE INVENTION

An object of the present invention is to provide a method so as to alleviate the above disadvantages. The objects of the invention are achieved by a method which is characterized by what is stated in the independent claim 1. The preferred embodiments of the invention are disclosed in the dependent claims.

The invention is based on the idea of atomizing at least one liquid precursor into liquid droplets in a deposition chamber for producing aerosol and filling the deposition chamber with aerosol for forming saturated aerosol comprising coating material in the deposition chamber and gravitational settling of the aerosol droplets towards a surface of the substrate for coating the substrate in the deposition chamber. In other words the saturated aerosol falls down in the deposition chamber by gravitation and a surface of a substrate is coated by the aerosol droplets in the deposition chamber, the aerosol droplets comprising coating material from the precursor.

The invention is based on the idea of creating saturated aerosol in an atmospheric state in the deposition chamber and forming a thin film on the surface of the substrate for coating the substrate. The saturated aerosol droplets settle by gravitation toward the substrate. The deposition chamber stays by its whole volume in a saturated state (when considered about the gas) such that the liquid film does not dry unmanageable but instead drying is achieved in a manageable way when the coated substrate is moved in a separate drying chamber. According to the invention coating the substrate is arranged by settling the liquid droplets of the saturated aerosol to the surface of the substrate for forming a thin film on the surface of the substrate by the droplets.

According to one embodiment of the invention at least one atomizer is arranged in the upper part of the deposition chamber for atomizing the at least one liquid precursor into liquid droplets.

In this application coating material or material means the precursor, i.e. the material that is atomized into aerosol.

The gravitation causes that the saturated aerosol becomes less dense when falling down in the deposition chamber and when touching the surface of the substrate the bigger droplets from the saturated aerosol fall down on the surface of the substrate to coat the substrate and the rest of the aerosol comprising smaller droplets moves upward in the deposition chamber so that in one embodiment of the invention excess aerosol is exhausted from the deposition chamber in the upper part of the deposition chamber the for the re-use of the coating material. In other words, the gravitation causes that different sized droplets move in different velocity and this causes collisions between droplets which in turn causes that bigger droplets are generated. This means that gravitational settling develops and more collisions are caused. All this eventually means that on the upper side of the atomizer concentration of the aerosol is reduced and the density becomes less and when excess aerosol is removed from the upper part of the deposition chamber this excess aerosol comprises only a little part of the original material. This material can be separated from the removed aerosol and be reused again. Material means the coating material of the substrate, i.e. the precursors. In a state where the deposition chamber is full of aerosol the same amount of aerosol that is fed to the deposition chamber has to be removed therefrom, otherwise the aerosol would penetrate in every opening of the deposition chamber. In other words, the method comprises a step of removing or recycling a remaining part of the saturated aerosol from the deposition chamber after the coating of the substrate. The method may comprise a step of collecting deposited precursor from the bottom of the deposition chamber for removing or recycling the precursor. The method may also comprise a step of collecting deposited precursor from the walls of the deposition chamber for removing or recycling the precursor. The method may further comprise a step of removing an excess aerosol from the deposition chamber through an opening and separating precursor from the excess aerosol for removing or recycling the precursor.

The aerosol is denser when coming out from the atomizers than after the larger droplets of the aerosol have coated the substrate. This causes a whirl inside the deposition chamber because of the continuous production of aerosol and coating of the substrate, i.e. because of the difference between the densities in different parts of the deposition chamber. So near the surface of the substrate the aerosol moves slowly from the settling point toward the rising point and in turn near the atomizers the movement is opposite. The aerosol whirl inside the deposition chamber, i.e. a big whirl in the whole deposition chamber, moves about 0.1 m/s while the exit speed of the aerosol in the atomizer is about 300 m/s. The movement and the generation of the whirls can be affected by the form of the deposition chamber and the place where the atomizers are arranged. So a vertical movement is created in the deposition chamber the direction depending on the geometry of the deposition chamber. These slow aerosol whirls can be further used in levelling the coating of the surface of the substrate when the substrate moves through the deposition chamber in the bottom part of the chamber so that the film will become uniform transversely to the movement direction of the substrate. In one embodiment of the invention the position of the atomizer produces a slow whirl of the aerosol in the deposition chamber which together with the moving substrate will decrease the differences in the density of the aerosol and its effect to the evenness of the coating. In another embodiment of the invention the form of the deposition chamber produces a slow whirl of the aerosol in the deposition chamber which together with the moving substrate will decrease the differences in the density of the aerosol and its effect to the evenness of the coating. In yet another embodiment of the invention height of the deposition chamber produces a high aerosol column in the deposition chamber in which the differences of the aerosol produce equalizing effect in aerosol. In a preferred embodiment of the invention a horizontal or substantially horizontal movement is produced in the aerosol by a quick aerosol flow which produces turbulence in the aerosol in the deposition chamber in the level of the atomizers which produces an aerosol having a uniform density. This horizontal or substantially horizontal movement in the aerosol is preferably produced by an atomizer producing the aerosol but it may be produced by a gas flow as well. In general the an aerosol produced in an atomizer atomizing the at least one liquid precursor into liquid droplets in the deposition chamber for producing aerosol generates besides the aerosol flow also slow movement in the aerosol which whirls and affects in a levelling way to the coating of the substrate.

Part of the aerosol is deposited on the walls and on the ceiling of the deposition chamber and mostly on the bottom of the deposition chamber on those parts where there is no substrate. The structure of the deposition chamber is therefore designed so that all the liquid is flown to the bottom of the deposition chamber and removed from the bottom through an aperture so that it can be reused. Because the whole deposition chamber is in a saturated state when considering the gas there is no drying and all the collected material has not dried in any phase. This makes it possible that the material can be reused. Because the saturated aerosol is moved by gravitation the substrate to be coated is arranged in the bottom part of the deposition chamber. In a preferred embodiment of the invention the aerosol and the substrate are in a same temperature. The substrate may be moved in the deposition chamber such that the substrate is arranged to go through the saturated aerosol or the substrate may be stationary or almost stationary during the coating.

Although the droplets in the aerosol have a difference in the size the difference may not be great. In the method according to the invention the size of the liquid droplets is less than 25 μm. In a preferred embodiment of the invention the size of the liquid droplets is less than 10 μm and in a further embodiment of the invention the size of the liquid droplets is 1-5 μm. In an embodiment according to the invention the saturated aerosol comprises coating material 0.5%-4% by volume.

The saturated aerosol spreads in the deposition chamber uniformly filling the deposition chamber. The saturated aerosol has saturation vapour pressure which is defined by the publication Aerosol Technology by William C. Hinds (A Wiley-Interscience Publication) in the following: “The saturation vapour pressure, also called the vapour pressure, is the pressure required to maintain a vapour in mass equilibrium with the condensed vapour (liquid or solid) at a specific temperature. When the partial pressure of a vapour equals its saturation vapour pressure, evaporation from the surface of a liquid just equals condensation on that surface and there is mass equilibrium at the surface. The pressure in any sealed container that contains only a liquid and its vapour is the saturation vapour pressure of that material at the temperature of the container. A sealed container that contains air and liquid water in equilibrium will have a partial pressure of water vapour equal to the saturation vapour pressure of water at the temperature of the container.”

The method comprises the steps of providing a source of at least one liquid precursor, atomizing the at least one liquid precursor into liquid droplets for producing aerosol in the deposition chamber, filling the deposition chamber with aerosol for forming saturated aerosol in the deposition chamber, and settling saturated aerosol by gravitation towards a surface of the substrate for coating the substrate in the deposition chamber.

The saturated aerosol may be produced in different ways because liquid can be atomized into small droplets by a plurality of different techniques, such as with a gas-dispersing atomizer, a pressure-dispersing atomizer and an ultrasound atomizer. The saturated aerosol can be produced for example by arranging two atomizing heads toward each other such that the aerosol jets discharged from the atomizing heads collide with each other in a collision point such that a planar aerosol plane is created preferably in a substantially horizontal direction. When these kinds of aerosol planes are created continuously the deposition chamber fills and eventually saturated aerosol is produced. Another way of creating saturated aerosol is to arrange at least one ultrasound source having an ultrasonic atomizer in the deposition chamber and converting at least one liquid precursor into aerosol such that saturated aerosol is produced in the deposition chamber.

The deposition chamber may be a closed deposition chamber so that it comprises a bottom wall, a top wall and side walls. Although being closed the deposition chamber may have openings for the substrate to go through the deposition chamber but the openings preferably have some kind of a closure flap or other gating arrangement, for example in a form of a gas. In other words the deposition chamber comprises a closed upper part and openings for the substrate in the lower part of the deposition chamber. When having an opening for the substrate in the deposition chamber the pressure between the deposition chamber and the outside world must be balanced so that there is no difference in pressure. One way is to control in exhaust flow and have it the same as the atomized aerosol flow. In another embodiment of the invention the deposition chamber may be at least partly open on the upper part of the deposition chamber such that when the deposition chamber is full of aerosol the extra aerosol spreads out from the deposition chamber from the opening in the upper part or even a small opening in the ceiling of the deposition chamber is enough so that aerosol can escape through it. So the deposition chamber may be a cylinder like chamber having an open top or it may have a roof like cover on top of it.

Relevant for the method according to the invention is that the atomizing process happens in the deposition chamber so that the aerosol is produced and is brought to the saturated state in the same chamber as the coating is applied on the surface of the substrate.

An advantage of the method of the invention is that the coating spreads on the surface of the substrate evenly and that the coating on the surface of the substrate is uniform. Another advantage of the method according to the invention is that the saturated aerosol has no specific direction but it is planar and radial at the same time so that it will spread out uniformly in a large area.

### BRIEF DESCRIPTION OF THE DRAWINGS

In the following the invention will be described in greater detail by means of preferred embodiments with reference to the attached drawings, in which

FIG. 1 shows one example of creating a planar aerosol plane in a deposition chamber; and

FIG. 2 shows a different phase of the example shown in FIG. 1 in which the aerosol spreads in the deposition chamber.

### DETAILED DESCRIPTION OF THE INVENTION

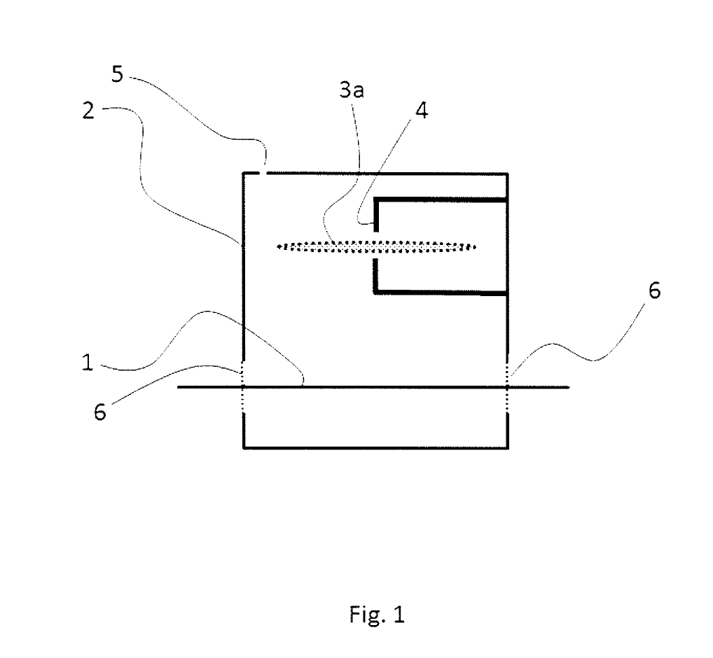

FIG. 1 shows a deposition chamber 2 having a substrate 1 in the bottom part of the deposition chamber 2 and an atomizer 4 arranged in the upper part of the deposition chamber 2. In this embodiment the deposition chamber 2 is a closed deposition chamber such that there are openings 6 only for the substrate 1 to enter and exit the deposition chamber 2 and an opening 5 for aerosol exit on the ceiling of the deposition chamber 2. The openings 6 are preferably controlled by for example a gas flow in the opening. The atomizer 4 can be different than what is shown in this figure and the method according to the invention is not limited to a specific way of creating saturated aerosol. In this example the at least one liquid precursor is atomized in two atomizing heads that are arranged in a vertical direction such that the heads are facing toward each other. The aerosol jets collide each other in a collision point in a midpoint from the opposing atomizing heads. The collision creates first a planar aerosol plane 3a which spreads radially and symmetrically in the deposition chamber 2. In this embodiment the atomizers are arranged in the middle of the deposition chamber so that the saturated aerosol will spread uniformly in the chamber but the atomizers can also be placed in another position which affects the spreading of the saturated aerosol and generate a large and slow aerosol whirl having the dimensions of the whole deposition chamber 2. FIG. 1 shows a starting point for the process.

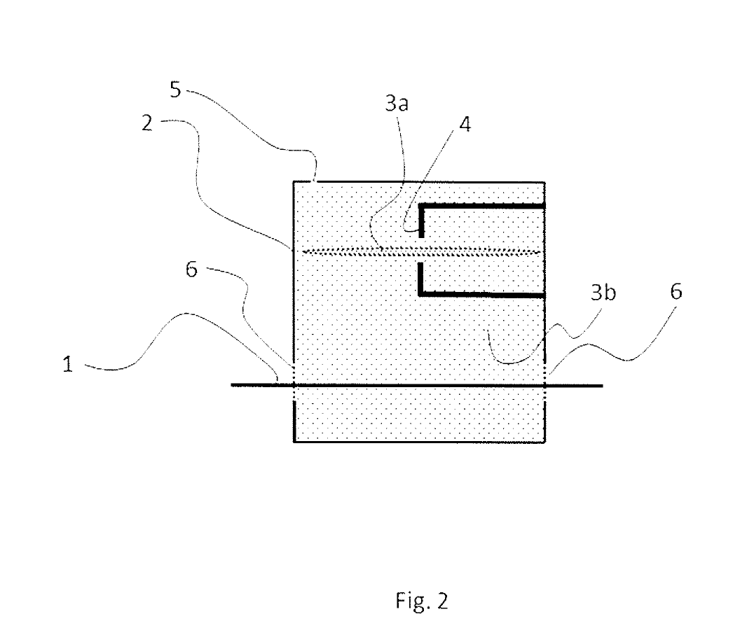

FIG. 2 shows what takes place in the deposition chamber 2 when the deposition chamber 2 is filled with aerosol such that saturated aerosol is created. In the figure the two atomizers 4 continuously atomize liquid precursor into liquid droplets such that a planar aerosol plane 3a is produced. The produced aerosol plane 3a spreads in the deposition chamber 2 and unites with other aerosol planes 3a so that the deposition aerosol flux 3b is formed. When the deposition chamber 2 is full of aerosol it becomes also saturated. The saturated aerosol falls down to the bottom part of the deposition chamber 2 where the substrate 1 is arranged and the droplets of the saturated aerosol are gravitationally settled on the surface of the substrate to form a thin film on the surface of the substrate 1. The atomizers 4 produce planar aerosol planes 3a continuously and the gravitation affects to the produced planar aerosol planes 3a which finally fill the deposition chamber 2 and become saturated. The saturated aerosol falls down in the deposition chamber 2 toward the substrate. This continuous aerosol output creates a bigger and bigger aerosol flux 3b that eventually becomes saturated. The aerosol falls towards the surface of the substrate 1 on the bottom of the deposition chamber 2. The substrate 1 may be stationary in the deposition chamber 2 or it may be moved through the deposition chamber 2 and through the saturated aerosol. The coating of the substrate 1 is arranged in the deposition chamber 2 in which the aerosol is in a saturated state and therefore the droplets do not dry up, i.e. evaporate.

It will be obvious to a person skilled in the art that, as the technology advances, the inventive concept can be implemented in various ways. The invention and its embodiments are not limited to the examples described above but may vary within the scope of the claims.

1.-17. (canceled)

18. A method of coating a substrate in a deposition chamber, wherein the method comprising the steps of:
providing a source of at least one liquid precursor;
atomizing the at least one liquid precursor into liquid droplets in the deposition chamber for producing aerosol;
filling the deposition chamber with aerosol for forming saturated aerosol in the deposition chamber; and
settling saturated aerosol by gravitation towards a surface of the substrate for coating the substrate in the deposition chamber.

19. The method according to claim 18, wherein a size of the liquid droplets is less than 25 μm.

20. The method according to claim 18, wherein a size of the liquid droplets is less than 10 μm.

21. The method according to claim 18, wherein a size of the liquid droplets is 1-5 μm.

22. The method according to claim 18, wherein the deposition chamber comprises a closed upper part and openings for the substrate in the lower part of the deposition chamber.

23. The method according to claim 18, wherein the deposition chamber is at least partly open on the upper side of the deposition chamber.

24. The method according to claim 18, wherein the method further comprising a step of:
removing or recycling a remaining part of the saturated aerosol from the deposition chamber after the coating of the substrate.

25. The method according to claim 18, wherein the method comprising a step of:
collecting deposited precursor from the bottom of the deposition chamber for removing or recycling the precursor.

26. The method according to claim 18, wherein the method comprising a step of:
collecting deposited precursor from the walls of the deposition chamber for removing or recycling the precursor.

27. The method according to claim 18, wherein the method comprising a step of:
removing an excess aerosol from the deposition chamber through an opening and separating precursor from the excess aerosol for removing or recycling the precursor.

28. The method according to claim 18, wherein the method further comprising a step of:
arranging the substrate in the bottom part of the deposition chamber.

29. The method according to claim 18, wherein the method comprises a step of:
arranging the substrate to go through the saturated aerosol.

30. The method according to claim 18, wherein the method comprises a step of:
coating the substrate by settling the liquid droplets of the saturated aerosol to the surface of the substrate for forming a thin film on the surface of the substrate by the droplets.

31. The method according to claim 18, wherein the method further comprising a step of:
creating a planar aerosol plane in a substantially horizontal direction.

32. The method according to claim 18, wherein the method further comprising a step of:
arranging at least one atomizer in the upper part of the deposition chamber for atomizing the at least one liquid precursor into liquid droplets.

33. The method according to claim 18, wherein the method further comprising a step of:
arranging at least one atomizer in the middle of the deposition chamber for atomizing the at least one liquid precursor into liquid droplets.

34. The method according to claim 18, wherein the saturated aerosol comprises coating material 0.5%-4% by volume.
